(19) United States
(12) Patent Application Publication
(10) Pub. No.: US 2010/0251267 A1
(43) Pub. Date: Sep. 30, 2010

(54) Caching of SCSI I/O referrals

(76) Inventors: Ross E. Zwisler, Lafayette, CO (US); Andrew J. Spry, Wichita, KS (US); Gerald J. Fredin, Wichita, KS (US); Kenneth J. Gibson, Lafayette, CO (US)

Correspondence Address: LSI Corporation c/o Suiter Swantz pc llo, 14301 FNB Parkway, Suite 220, Omaha, NE, 68154, US

(21) Appl. No.: 12/383,396

(22) Filed: Mar. 24, 2009

(51) Int. Cl. G06F 9/44; G06F 12/08; G06F 12/06

(52) U.S. Cl. 719/326; 711/118; 711/209; 711/E12.017; 711/E12.078

(57) ABSTRACT

The present disclosure is directed to a method for communication between an initiator system and a block storage cluster. The method may comprise receiving a first referral response from a first storage system included in a plurality of storage systems of the block storage cluster, the first referral response providing information for directing the initiator system to a second storage system included in the plurality of storage systems of the block storage cluster; obtaining a starting logical block address (LBA) and a corresponding port identifier based on the first referral response; storing the starting LBA and the corresponding port identifier in a referral cache accessible to the initiator system; and directing an input/output (I/O) request from the initiator system to the block storage cluster based on the starting LBA and the corresponding port identifier stored in the referral cache.

### FIELD OF THE INVENTION

The present invention relates to the field of electronic data storage and particularly to a system and method for providing caching of Small Computer System Interface (SCSI) Input/Output (I/O) referrals.

### BACKGROUND OF THE INVENTION

Small Computer System Interface (SCSI) Input/Output (I/O) referral techniques may be utilized to facilitate communication between an initiator system and a block storage cluster. For example, the initiator system (e.g., a data requester) may transmit a data request command to a first storage system of the block storage cluster. If the data requested is stored in the first storage system, the data may be retrieved and transferred to the initiator system. However, if a portion of the data requested is not stored by the first storage system, but is stored by a second storage system of the block storage cluster, a referral response may be transmitted from the first storage system to the initiator system. The referral response may provide an indication to the initiator system that not all of the requested data was transferred. The referral response may further provide information for directing the initiator system to the second storage system. Currently available storage systems may not be configured for providing caching of such referral responses.

Therefore, it may be desirable to provide a storage system which addresses the above-referenced problems of currently available storage system solutions.

### SUMMARY OF THE INVENTION

Accordingly, an embodiment of the present invention is directed to a method for communication between an initiator system and a block storage cluster. The method may comprise receiving a first referral response from a first storage system included in a plurality of storage systems of the block storage cluster, the first referral response providing information for directing the initiator system to a second storage system included in the plurality of storage systems of the block storage cluster; obtaining a starting logical block address (LBA) and a corresponding port identifier based on the first referral response; storing the starting LBA and the corresponding port identifier in a referral cache accessible to the initiator system; and directing an input/output (I/O) request from the initiator system to the block storage cluster based on the starting LBA and the corresponding port identifier stored in the referral cache.

A further embodiment of the present invention is directed to a storage system. The storage system may comprise means for receiving a first referral response from a first storage system included in a plurality of storage systems of a block storage cluster, the first referral response providing information for directing an initiator system to a second storage system included in the plurality of storage systems of the block storage cluster; means for obtaining a starting logical block address (LBA) and a corresponding port identifier based on the first referral response; means for storing the starting LBA and the corresponding port identifier in a referral cache accessible to the initiator system; and means for directing an input/output (I/O) request from the initiator system to the block storage cluster based on the starting LBA and the corresponding port identifier stored in the referral cache.

An additional embodiment of the present invention is directed to a computer-readable medium having computer-executable instructions for performing a method for communication between an initiator system and a block storage cluster. The method for communication between the initiator system and the block storage cluster may comprise receiving a first referral response from a first storage system included in a plurality of storage systems of the block storage cluster, the first referral response providing information for directing the initiator system to a second storage system included in the plurality of storage systems of the block storage cluster; obtaining a starting logical block address (LBA) and a corresponding port identifier based on the first referral response; storing the starting LBA and the corresponding port identifier in a referral cache accessible to the initiator system; and directing an input/output (I/O) request from the initiator system to the block storage cluster based on the starting LBA and the corresponding port identifier stored in the referral cache.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a networked storage implementation/system accessible via a block storage protocol in accordance with an exemplary embodiment of the present invention;

FIG. 2 is an illustration of a referral cache;

FIG. 3 is an illustration depicting logical block access distribution for an exemplary virtual volume;

FIG. 4 is an illustration of a populated referral cache;

FIG. 5 is another networked storage implementation/system accessible via a block storage protocol in accordance with another exemplary embodiment of the present invention;

FIG. 6 is an illustration of another referral cache;

FIG. 7 is an illustration of another populated referral cache; and

FIG. 8 is a flow chart illustrating a method for communication between an initiator system and a block storage cluster of the present disclosure, in accordance with an exemplary embodiment of the present disclosure.

### DETAILED DESCRIPTION OF THE INVENTION

Reference will now be made in detail to the presently preferred embodiments of the invention, examples of which are illustrated in the accompanying drawings.

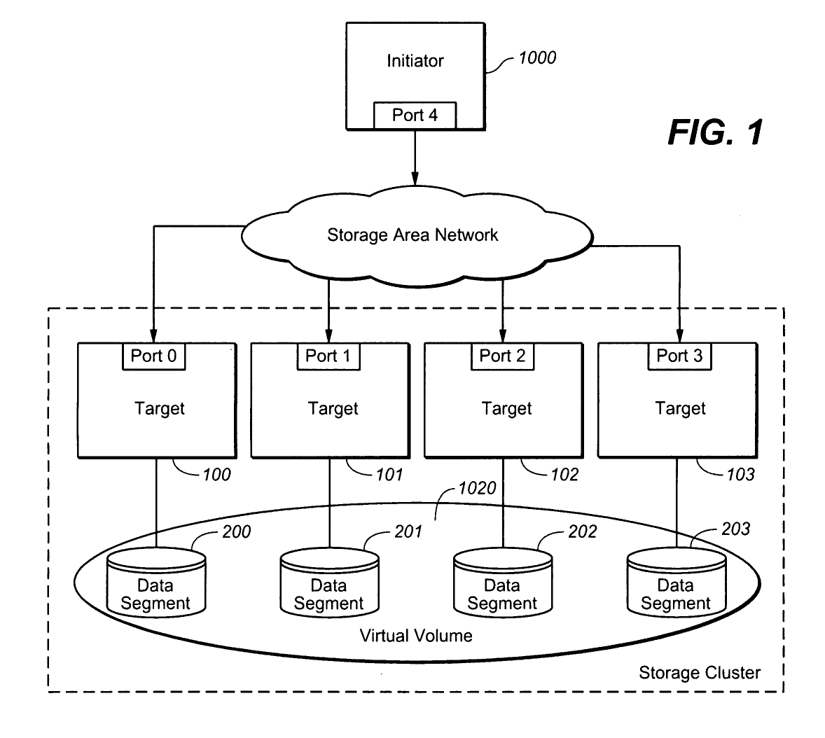

Referring to FIG. 1, a networked storage implementation/system accessible via a block storage protocol in accordance with an exemplary embodiment of the present disclosure is shown. An initiator system 1000 may be configured for accessing a block storage cluster 1020 via a storage area network.

Small Computer System Interface (SCSI) Input/Output (I/O) referral techniques may be utilized to facilitate communication between an initiator system 1000 and a block storage cluster 1020. For example, the initiator system (e.g., a data requester) may transmit a data request command to a first storage system (e.g., target 100 through port 0) included in a plurality of storage systems of the block storage cluster. When the data requested in the data request is stored in the first storage system, the data may be retrieved and transferred to the initiator system. However, when a portion of the data requested is not stored by the first storage system, but is stored by a second storage system (e.g., target 101) included in the block storage cluster, a referral response may be transmitted from the first storage system to the initiator system. The referral response may provide an indication to the initiator system that not all of the requested data was transferred. The referral response may further provide information for directing the initiator system to the second storage system (e.g., accessing target 101 through port 1).

SCSI I/O referral techniques may enable an initiator system to access data on Logical Unit Numbers (LUNs) that are spread across a plurality of storage/target devices. These target devices may be disks, storage arrays, tape libraries, and/or other types of storage devices. It is understood that an I/O request may be a SCSI command, the first storage system may be a SCSI storage system, and the initiator system may be a SCSI initiator system. The SCSI command may identify the requested data by a starting address of the data and a length of the data in a volume logical block address space.

Near linear performance scaling may be a concern when accessing virtual volumes spread across a plurality of target devices. However, large amounts of SCSI I/O referrals may negatively impact performances. This issue may become more noticeable as virtual volumes may be spread across an increasing number of target devices. For instance, consider a case in which data segments may be spread evenly behind two target devices. A random I/O directed at either target device may need to be redirected to the correct device approximately 50% of the time. This means that half of all I/Os may require a SCSI I/O referral to complete successfully. In general, if a virtual volume is evenly distributed among data segments behind N target devices, the probability that an I/O to a random logical block address (LBA) needs to be redirected may be (N-1)/N.

The present disclosure is directed to a method for communication between an initiator system and a block storage cluster. The performance penalties associated with I/O redirection via SCSI I/O referrals may be reduced or eliminated if the imitator systems cache referral information received from the block storage cluster. For example, a referral cache may be utilized and maintained for each virtual volume to keep track of the block boundaries between underlying data segments. The initiator may utilize the referral cache to correctly route I/O requests to its virtual volumes. The initiator may also split I/O requests that span multiple data segments when necessary.

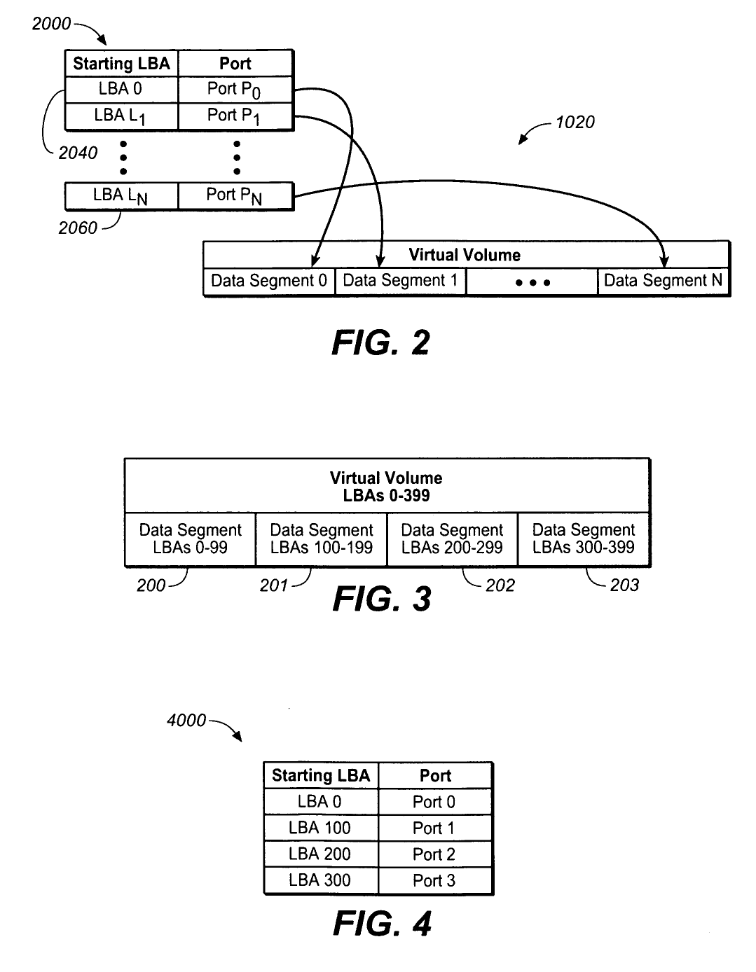

Referring to FIG. 2, a referral cache 2000, in accordance with an exemplary embodiment of the present disclosure is shown. When the initiator system 1000 receives a referral response, the starting LBA and the port identifier of the referral response may be obtained and stored in the referral cache 2000 accessible to the initiator system. Each row in the referral cache 2000 may include the starting LBA and the corresponding port identifier for referring to a particular data segment available in a virtual volume 1020. For example, a referred data stored in data segment X of a given virtual volume may start at the virtual volume's LBA Lx and accessible through port Pₓ. For instance, in the example illustrated in FIG. 2, row 2040 may store the starting LBA and the port identifier for accessing data segment 0, and row 2060 may store the starting LBA and the port identifier for accessing data segment N.

The referral cache may be populated over time based on the referral responses received. The initiator systems may utilize the data stored in their corresponding referral caches to direct/route I/O requests. For example, in one embodiment, when an I/O request needs to be transmitted from the initiator system to the block storage cluster, the initiator system may determine a requested LBA specified in the I/O request. The initiator system may locate the greatest starting LBA stored in the referral cache 2000 that is less than the requested LBA. The initiator may then direct the I/O request to the block storage cluster based on the greatest starting LBA and its corresponding port identifier.

In the illustrated configuration shown in FIG. 1, the block storage cluster (virtual volume) 1020 may comprise data segments 200, 201, 202 and 203. These data segments may be accessible through ports 0, 1, 2 and 3, respectively. If each of these data segments has a length of 100 blocks, the resulting virtual volume may have a length of 400 blocks. The LBA distribution for this exemplary virtual volume is depicted in FIG. 3. A fully populated initiator accessible referral cache 4000 corresponding to this configuration is depicted in FIG. 4.

For example, in the exemplary configuration described above, if the initiator system 1000 issues an I/O request to LBA 150 with length of 50 blocks, the initiator system 1000 may correctly direct the I/O request to the appropriate data segment utilizing the data stored in the referral cache 4000. In one embodiment, the initiator system 1000 may search in the referral cache 4000 to locate a data segment with the greatest starting LBA that is less than 150 (the requested LBA). In this example, data segment 201 has the greatest starting LBA of 100 that is less than the requested LBA of 150. Therefore, the initiator system 1000 may direct the I/O request to data segment 201 through a corresponding port stored in the referral cache 4000, i.e., port 1 in this example.

It is contemplated that the initiator 1000 may also utilize information stored in the referral cache to correctly split I/O requests that may span multiple target devices. For example, utilizing the LBA and length specified in a given I/O request, the initiator may calculate whether this given I/O request spans multiple data segments. If the I/O request does span multiple data segments, the initiator may split the I/O request into multiple child I/O requests along the data segment boundaries. Each of the child I/O requests may then be directed to its appropriate data segment as previously described. The initiator may be configured for aggregating the responses received from the child I/O requests and returning status for the original I/O requests as appropriate.

For example, consider an I/O request to LBA 150 with length of 100 blocks in the same configuration as illustrated in FIGS. 3 and 4. Since this I/O request accesses LBAs 150 through 249, it spans both data segment 201 and data segment 202. Based on the data stored in the referral cache 4000, the initiator may detect this situation and may split the I/O request along the data segment boundary between segment 201 and 202. For instance, the original I/O request may be split into the following two child I/O requests:

Port 1, LBA 150, Length 50

Port 2, LBA 200, Length 50

Each of these child I/O requests may be performed without any further referral responses. The initiator may be configured to aggregate the responses received from these two child I/O requests and return the aggregated results for the original I/O request.

It is understood that with a fully populated referral cache, an initiator may be able to correctly route all virtual volume I/O requests. An initiator may also be able to correctly split all virtual volume I/O requests that cross data segment boundaries. Therefore, unless an error or configuration change occurs, all I/O requests may be directed successfully without the need for further referral responses by utilizing a fully populated referral cache. It is also understood that the number of data segments that may be spanned by a single virtual volume I/O request may be unlimited.

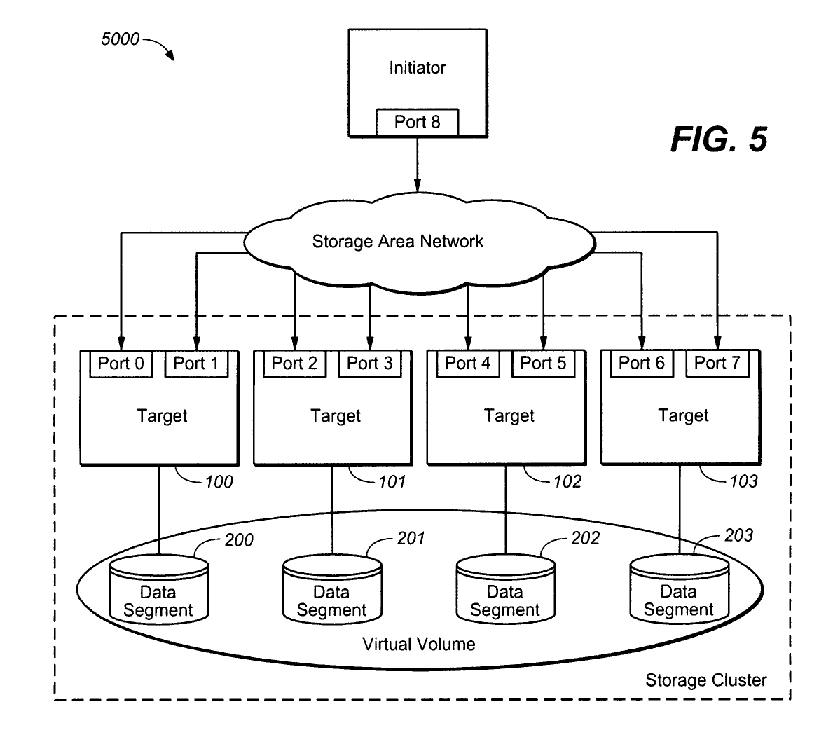

In an alternative embodiment, the referral cache may be augmented to support multipathing. An exemplary configuration with multipathing 5000 is illustrated in FIG. 5. In a multipathed storage area network, more than one path may be provided for accessing a data segment in the virtual volume.

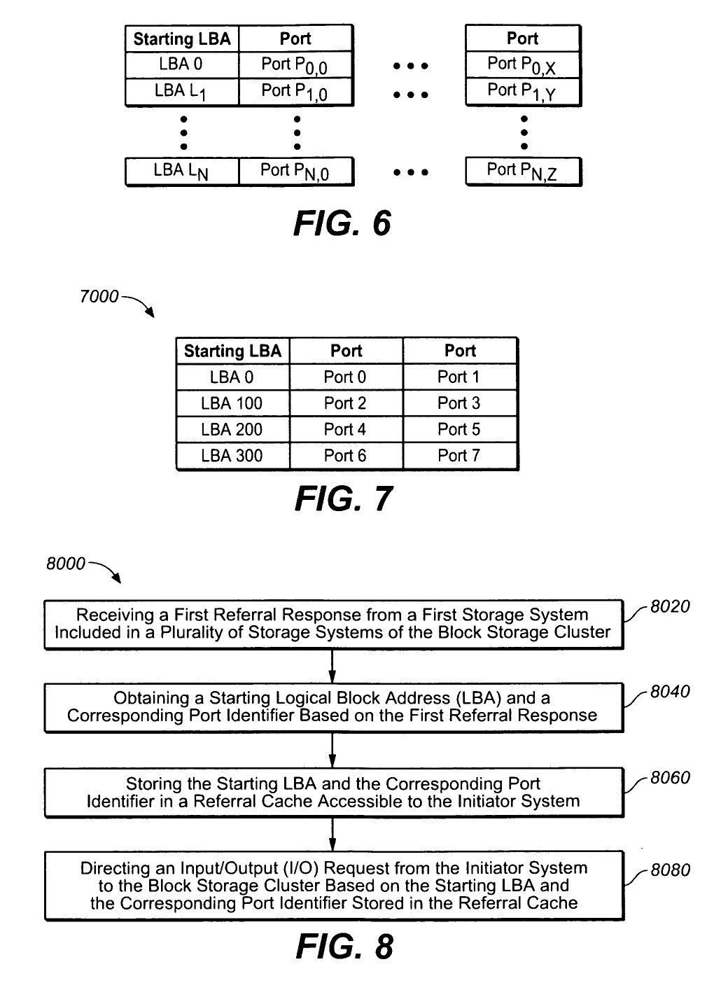

FIG. 6 shows a referral cache with multipathing support. The referral cache may be configured so that it supports multiple ports per data segment (LBA). It is understood that each data segment may be associated with a different number of ports.

For example, if each of the data segments in the multipath configuration 5000 has a length of 100 blocks, the resulting virtual volume may have a length of 400 blocks. FIG. 7 depicts a fully populated initiator accessible referral cache 7000 for this multipathing configuration. The initiator may direct an I/O request from the initiator to the block storage cluster based on information stored in the referral cache 7000.

It is contemplated that in a system comprising multiple initiators, not all initiators are required to implement referral caching. For example, a first initiator may be configured with referral caching of the present disclosure, while a second initiator may be configured without referral caching. It is also contemplated that the initiators may not be required to communicate with one another to implement referral caching. That is, virtual volume referral caches may be implemented and/or utilized completely independently, and such referral caches may not need to be synchronized between initiators. Therefore, no metadata locks may be necessary among the initiators.

It is also contemplated that an initiator may or may not persistently store the contents of the referral cache. If the referral cache is not persisted and the initiator reboots, for instance, the initiator may rebuild its referral caches once it resumes I/O operations to its virtual volumes.

It is understood that target devices (e.g., particular storage devices in the block storage cluster) may not be required to inform initiators before they change virtual volume configurations. For example, if a virtual volume configuration is changed without informing the initiator, the initiator may direct an I/O request based on an outdated cached data. If the cached data is incorrect due to the configuration change, a new referral response may be transmitted to the initiator by the storage cluster, and the initiator may redirect the I/O request and update its referral cache based on the referral response. That is, the initiator may relearn the virtual volume configuration dynamically.

Similarly, referral caching may not introduce any risks that an initiator may corrupt data because it has a stale or invalid virtual volume cache. Incorrect virtual volume cache entries may result in incorrect I/O routing. This incorrect routing may cause the initiator to receive updated referral responses, similar to an outdated referral cache record described above.

It may be appreciated to configure the target devices to maintain a revision number for the virtual volume's configuration. For example, this revision number may be communicated to initiators as part of the referral list. If the layout of a virtual volume is altered, a change in this revision number may inform the initiators that the layout stored in their referral cache may be stale. The initiators may choose to flush and rebuild their cache based on information of the new layout. It is contemplated that if the majority of the virtual volume configuration stays consistent, the target device may choose not to change the revision number, resulting in a cache update but not a cache flush on the initiator. It is also contemplated that if a virtual volume layout change is temporary, it may be beneficial to allow target devices to flag such referrals as non-cacheable.

FIG. 8 shows a flow diagram illustrating steps performed by a communication method 8000 in accordance with the present disclosure. The method 8000 may be utilized in a storage system for communication between an initiator system and a block storage cluster. Step 8020 may receive a first referral response from a first storage system included in a plurality of storage systems of the block storage cluster. The first referral response may provide information for directing the initiator system to a second storage system included in the block storage cluster.

Step 8040 may obtain a starting logical block address (LBA) and a corresponding port identifier based on the first referral response. The starting LBA and the port identifier may be obtained by processing the first referral response utilizing a processor coupled to the initiator.

Step 8060 may store the starting LBA and the corresponding port identifier in a referral cache accessible to the initiator system. Step 8080 may direct an I/O request from the initiator system to the block storage cluster based on the information stored in the referral cache as previously described.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for communication between an initiator system and a block storage cluster, comprising:
receiving a first referral response from a first storage system included in a plurality of storage systems of the block storage cluster, the first referral response providing information for directing the initiator system to a second storage system included in the plurality of storage systems of the block storage cluster;
obtaining a starting logical block address (LBA) and a corresponding port identifier based on the first referral response;
storing the starting LBA and the corresponding port identifier in a referral cache accessible to the initiator system; and
directing an input/output (I/O) request from the initiator system to the block storage cluster based on the starting LBA and the corresponding port identifier stored in the referral cache.

2. The method as claimed in claim 1, further comprising:
receiving a plurality of referral responses from the plurality of storage systems of the block storage cluster;
obtaining a plurality of starting LBAs and a plurality of corresponding port identifiers based on the plurality of referral responses;
storing the plurality of starting LBAs and the plurality of corresponding port identifiers in the referral cache accessible to the initiator system; and
directing the I/O request from the initiator system to the block storage cluster based on the plurality of starting LBAs and the plurality of corresponding port identifiers stored in the referral cache.

3. The method as claimed in claim 2, wherein directing the I/O request from the initiator system to the block storage cluster further comprising:
determining a requested LBA specified in the I/O request;
locating within the referral cache a greatest starting LBA that is less than the requested LBA; and
directing the I/O request to the block storage cluster based on the greatest starting LBA and the corresponding port identifier for the greatest starting LBA.

4. The method as claimed in claim 2, wherein directing the I/O request from the initiator system to the block storage cluster further comprising:
determining a requested length specified in the I/O request;
determining whether the I/O request spans more than one data segment;
splitting the I/O request into a plurality of child I/O requests along at least one data segment boundary when the I/O request spans more than one data segment; and
directing each of the plurality of child I/O requests to the block storage cluster based on the plurality of starting LBAs and the plurality of corresponding port identifiers stored in the referral cache.

5. The method as claimed in claim 1, wherein the referral cache is configured for storing at least one port identifier for each starting LBA stored.

6. The method as claimed in claim 1, wherein the I/O request is a Small Computer System interface (SCSI) command, the first storage system is a SCSI storage system, and the initiator system is a SCSI initiator system.

7. The method as claimed in claim 6, wherein the SCSI command identifies the requested data by a starting address of the data and a length of the data in a volume logical block address space.

8. A storage system, comprising:
means for receiving a first referral response from a first storage system included in a plurality of storage systems of a block storage cluster, the first referral response providing information for directing an initiator system to a second storage system included in the plurality of storage systems of the block storage cluster;
means for obtaining a starting logical block address (LBA) and a corresponding port identifier based on the first referral response;
means for storing the starting LBA and the corresponding port identifier in a referral cache accessible to the initiator system; and
means for directing an input/output (I/O) request from the initiator system to the block storage cluster based on the starting LBA and the corresponding port identifier stored in the referral cache.

9. The storage system as claimed in claim 8, further comprising:
means for receiving a plurality of referral responses from the plurality of storage systems of the block storage cluster;
means for obtaining a plurality of starting LBAs and a plurality of corresponding port identifiers based on the plurality of referral responses;
means for storing the plurality of starting LBAs and the plurality of corresponding port identifiers in the referral cache accessible to the initiator system; and
means for directing the I/O request from the initiator system to the block storage cluster based on the plurality of starting LBAs and the plurality of corresponding port identifiers stored in the referral cache.

10. The storage system as claimed in claim 9, wherein the directing means further comprising:
means for determining a requested LBA specified in the I/O request;
means for locating within the referral cache a greatest starting LBA that is less than the requested LBA; and
means for directing the I/O request to the block storage cluster based on the greatest starting LBA and the corresponding port identifier for the greatest starting LBA.

11. The storage system as claimed in claim 9, wherein the directing means further comprising:
means for determining a requested length specified in the I/O request;
means for determining whether the I/O request spans more than one data segment;
means for splitting the I/O request into a plurality of child I/O requests along at least one data segment boundary when the I/O request spans more than one data segment; and
means for directing each of the plurality of child I/O requests to the block storage cluster based on the plurality of starting LBAs and the plurality of corresponding port identifiers stored in the referral cache.

12. The storage system as claimed in claim 8, wherein the referral cache is configured for storing at least one port identifier for each starting LBA stored.

13. The storage system as claimed in claim 8, wherein the I/O request is a Small Computer System interface (SCSI) command, the first storage system is a SCSI storage system, and the initiator system is a SCSI initiator system.

14. The storage system as claimed in claim 8, wherein the SCSI command identifies the requested data by a starting address of the data and a length of the data in a volume logical block address space.

15. A computer-readable medium having computer-executable instructions for performing a method for communication between an initiator system and a block storage cluster, said method comprising:
receiving a first referral response from a first storage system included in a plurality of storage systems of the block storage cluster, the first referral response providing information for directing the initiator system to a second storage system included in the plurality of storage systems of the block storage cluster;
obtaining a starting logical block address (LBA) and a corresponding port identifier based on the first referral response;
storing the starting LBA and the corresponding port identifier in a referral cache accessible to the initiator system; and
directing an input/output (I/O) request from the initiator system to the block storage cluster based on the starting LBA and the corresponding port identifier stored in the referral cache.

16. The computer-readable medium as claimed in claim 15, wherein said method further comprising:
receiving a plurality of referral responses from the plurality of storage systems of the block storage cluster;
obtaining a plurality of starting LBAs and a plurality of corresponding port identifiers based on the plurality of referral responses;
storing the plurality of starting LBAs and the plurality of corresponding port identifiers in the referral cache accessible to the initiator system; and
directing the I/O request from the initiator system to the block storage cluster based on the plurality of starting LBAs and the plurality of corresponding port identifiers stored in the referral cache.

17. The computer-readable medium as claimed in claim 16, wherein directing the I/O request from the initiator system to the block storage cluster further comprising:
determining a requested LBA specified in the I/O request;
locating within the referral cache a greatest starting LBA that is less than the requested LBA; and
directing the I/O request to the block storage cluster based on the greatest starting LBA and the corresponding port identifier for the greatest starting LBA.

18. The computer-readable medium as claimed in claim 16, wherein directing the I/O request from the initiator system to the block storage cluster further comprising:
determining a requested length specified in the I/O request;
determining whether the I/O request spans more than one data segment;
splitting the I/O request into a plurality of child I/O requests along at least one data segment boundary when the I/O request spans more than one data segment; and
directing each of the plurality of child I/O requests to the block storage cluster based on the plurality of starting LBAs and the plurality of corresponding port identifiers stored in the referral cache.

19. The computer-readable medium as claimed in claim 15, wherein the referral cache is configured for storing at least one port identifier for each starting LBA stored.

20. The computer-readable medium as claimed in claim 15, wherein the I/O request is a Small Computer System interface (SCSI) command, the first storage system is a SCSI storage system, and the initiator system is a SCSI initiator system.
